(19) United States
(12) Patent Application Publication
(10) Pub. No.: US 2003/0128245 A1
(43) Pub. Date: Jul. 10, 2003

(54) Method and apparatus for transferring information between a printer portion and a replaceable printing component

(76) Inventor: Ray A. Walker, Eugene, OR (US)

Correspondence Address: HEWLETT-PACKARD COMPANY, Intellectual Property Administration, P.O. Box 272400, Fort Collins, CO, 80527-2400, US

(21) Appl. No.: 10/044,476

(22) Filed: Jan. 10, 2002

(51) Int. Cl. B41J 2/195

(52) U.S. Cl. 347/7

(57) ABSTRACT

The present disclosure relates to a replaceable printing component for use in a printing system. The replaceable printing component contains a supply of printing material for use by the printing system to form images on media. The replaceable printing component includes a reservoir for containing printing material. Also included is a linking device disposed entirely within the reservoir for providing a signal indicative printing material within the reservoir. The reservoir is formed of a material so that the signal is coupled through the reservoir for providing information to the printing system.

### BACKGROUND OF THE INVENTION

The present invention is related to inkjet printing devices. More particularly, the present invention is related to inkjet printing devices that make use of a wireless link for transferring information from a replaceable ink container to a printer portion.

Inkjet printers frequently make use of an inkjet printhead mounted within a carriage that is moved back and forth across print media, such as paper. As the printhead is moved across the print media, a control system activates the printhead to deposit or eject ink droplets onto the print media to form images and text. Ink is provided to the printhead by a supply of ink that is either carried by the carriage or mounted to the printing system that does not to move with the carriage. For the case where the ink supply is not carried with the carriage, the ink supply can be in fluid communication with the printhead to replenish the printhead or the printhead can be intermittently connected with the ink supply by positioning the printhead proximate to the filling station whereupon the printhead is replenished with ink from the refilling station.

For the case where the ink supply is carried with the carriage, the ink supply may be integral with the printhead whereupon the entire printhead and ink supply is replaced when ink is exhausted. Alternatively, the ink supply can be carried with the carriage and be separately replaceable from the printhead or drop ejection portion.

Regardless of where the supply of ink is located within the printing system, it is critical that the printhead be prevented from operating when the supply of ink is exhausted. Operation of the printhead once the supply of ink is exhausted results in poor print quality, printhead reliability problems, and, if operated for a sufficiently long time without a supply of ink, can cause catastrophic failure of the printhead. This catastrophic failure results in permanent damage to the printhead. Therefore, it is important that the printing system be capable of reliably identifying a condition in which the ink supply is nearly or completely exhausted. This technique should be accurate, reliable, and relatively low cost, thereby tending to reduce the cost of the printing system.

### SUMMARY OF THE INVENTION

One aspect of the exemplary embodiment is a replaceable printing component for use in a printing system. The replaceable printing component contains a supply of printing material for use by the printing system to form images on media. The replaceable printing component includes a reservoir for containing printing material. Also included is a linking device disposed entirely within the reservoir for providing a signal indicative of printing material within the reservoir. The reservoir is formed of a material so that the signal is coupled through the reservoir for providing information to the printing system.

Another aspect of the exemplary embodiment is a printing system having a printer portion and at least one replaceable reservoir. The printer portion and the at least one replaceable reservoir are configured to exchange information therebetween. The printing system includes a first wireless link associated with the replaceable reservoir. The first wireless link is disposed entirely within the replaceable reservoir. Also included is a second wireless link associated with the printer portion. The second wireless link receives replaceable reservoir information from the first wireless link by transmission of information in a wireless manner.

Yet another aspect of the exemplary embodiment is a replaceable ink container for providing ink to an inkjet printing system. The replaceable ink container includes a sensing system for sensing parameters of ink within an ink container. Ink type within the replaceable ink container is determined by the inkjet printing system based on the sensed parameters.

### BRIEF DESCRIPTION OF THE DRAWINGS

FIG. 1 depicts an exemplary embodiment of a printing system that incorporates a replaceable printing component, shown in a top perspective view with a printer cover open.

FIG. 2 is a simplified schematic of a replaceable printhead portion and an exemplary replaceable printing component that contains a sensor and a linking device for transferring information to a printer portion shown in FIG. 1.

FIG. 3 is a top perspective view of the sensor and the linking device that are disposed on a substrate.

FIG. 4 is a section view taken across lines 4-4 of the substrate, sensor, and linking device of FIG. 3 shown encapsulated by an encapsulant.

FIG. 5 is a simplified block diagram of the linking device associated with the replaceable printing component and a linking device associated with the printer portion for transferring information therebetween.

FIG. 6 is a simplified block diagram of senor electronics shown in FIG. 5 for processing sensor information.

### DETAILED DESCRIPTION OF AN EXEMPLARY EMBODIMENT

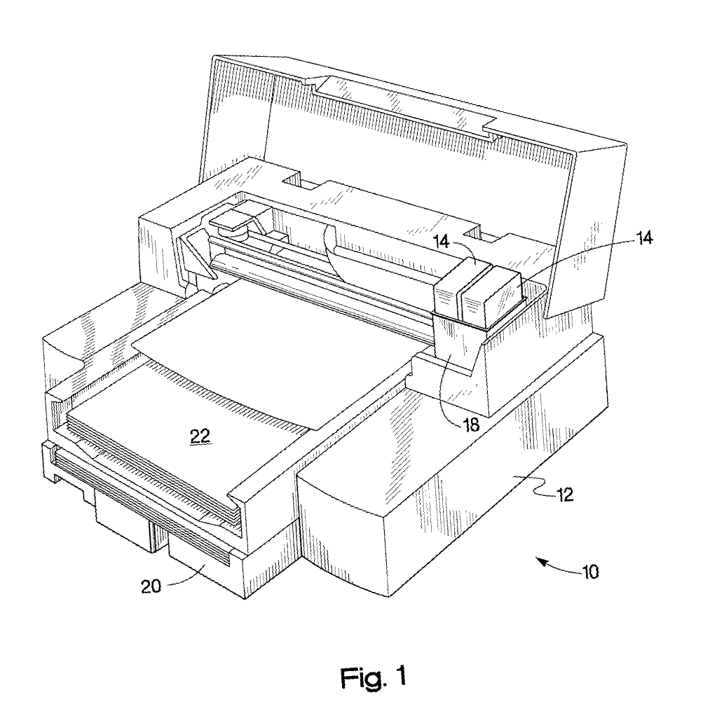

FIG. 1 is a perspective view of one exemplary embodiment of a printing system 10 of the present invention shown with its cover open. The printing system 10 includes a printer portion 12 and one or more replaceable printing components 14 installed therein. The printer portion 12 and the replaceable printing component(s) 14 together cooperate to accomplish printing on print media. Each replaceable printing component 14 includes a linking device (not shown) for exchanging information between the printer portion 12 and the replaceable printing component 14. The use of the linking device 16, together with a corresponding linking device (not shown) associated with the printer portion 12, allows the printer portion 12 to retrieve information and monitor status of the replaceable printing components 14.

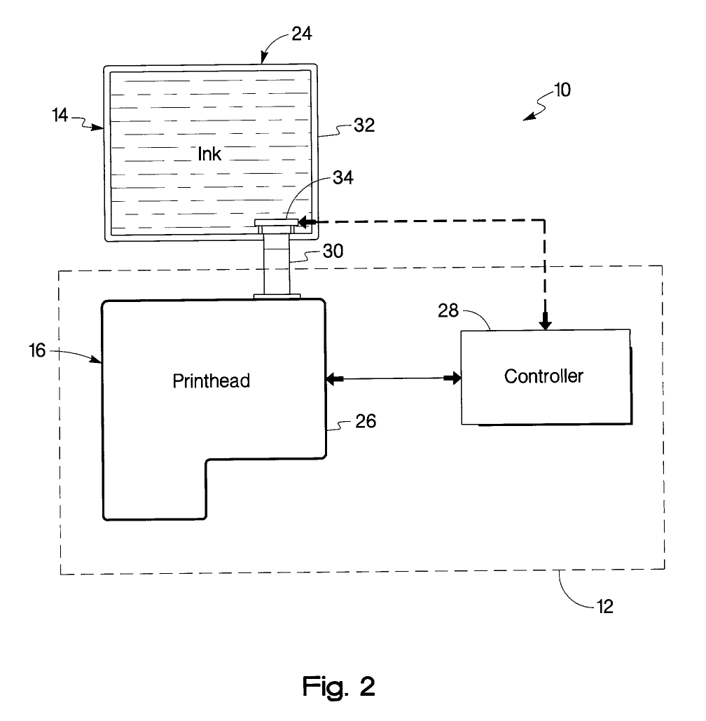

In one exemplary embodiment, the printing system 10 is an inkjet printing system. In this exemplary embodiment, the replaceable printing component 14 is an ink reservoir that is in fluid communication with an inkjet printhead portion that will be discussed with respect to FIG. 2. Each of the replaceable printing components 14 or ink reservoirs is installed in a scanning carriage 18 that is moved relative to print media. The inkjet printer portion 12 includes a media tray for receiving print media 22. As media step through a print zone, the scanning carriage moves the replaceable printing components 14 and printheads relative to the print media 22. The printer portion 12 selectively activates the printhead portion associated with the replaceable printing components 14 to deposit ink on print media to thereby accomplish printing.

The printing system shown in FIG. 1 is shown with two replaceable printing components 14, one representing an ink reservoir having separate chambers containing cyan, magenta and yellow inks, and one representing an ink reservoir containing black ink. The replaceable printing components 14 are used together to accomplish 4-color printing. The method and apparatus of the preferred embodiment is also applicable to printing systems 10 that make use of other arrangements such as printing systems that use greater or less than 4 ink colors, as in high fidelity printing which typically use 6 or more ink colors. In either case, the printing system 10 includes one or more replaceable printing components 14, each having a linking device (not shown) associated therewith for providing information to the printer portion 12.

The method and apparatus of the preferred embodiment is applicable to inkjet printing systems 10 having other configurations than those shown in FIG. 1. For example, the replaceable printing component 14 can be a printhead portion mounted on the scanning carriage 18, or a separate ink reservoir portion mounted off the scanning carriage that is in fluid communication either intermittently or continuously with the printhead portion. In this case, each of the printhead portion and the ink reservoir portion is a separate replaceable printing component 14. The ink reservoir portion is replaced when the ink is exhausted and the printhead portion is replaced at the end of life.

The method and apparatus of the preferred embodiment is applicable to replaceable components 14 other than the ink reservoir. For example, the technique of the preferred embodiment is suitable for use with replaceable printing components that become depleted with use such as toner reservoirs in the case of laser printing or reservoirs that contain fluid other that ink such as media coatings. The technique of the present disclosure allows for the collection of information from the replaceable printing components 14 by the printer portion 12. The customer is notified when a replaceable printing component 14 requires replacement.

FIG. 2 is a simplified schematic representation of the inkjet printing system 10 of the preferred embodiment shown in FIG. 1. In this simplified representation, the replaceable printing component 14 is shown as having two separately replaceable parts, a reservoir portion 24 and a printhead portion 26. The printing system 10 includes a controller 28 for providing activation signals to the printhead 26. The printhead 26 ejects a marking fluid such as ink in response to activation by the controller 26. The reservoir 24 is an ink reservoir that is used to replenish the printhead 26 with ink by way of a fluid conduit 30. The fluid conduit 30 fluidically couples the ink reservoir 24 with the printhead portion 26.

For simplicity, the ink reservoir 24 is shown as a single chamber ink reservoir containing one-ink color. The ink reservoir 24 alternatively is formed to have a plurality of chambers with each chamber having a different ink color for providing a plurality of different colored inks to a single printhead 26.

In the exemplary embodiment, the reservoir portion 24 includes a housing 32 formed from a plurality of sidewalls for containing a supply of ink. Ink is free to move about within the reservoir portion 24. Alternatively the ink reservoir 24 can include a porous material (not shown) having a capillary gradient for retaining ink. The capillary gradient tends to draw ink within the ink reservoir 24 toward a fluid outlet (not shown). In addition, the porous material provides backpressure for preventing ink from drooling from the printhead portion 26 in the event of temperature or pressure changes.

The replaceable printing component 14 includes a linking device 34 for exchanging information between the controller 28 on the printer portion 12 and the replaceable printing component 14. The use of the linking device 34, together with a corresponding linking device (not shown) associated with the printer portion 12, allows the printer portion 12 to retrieve information and monitor status of the replaceable printing components 14.

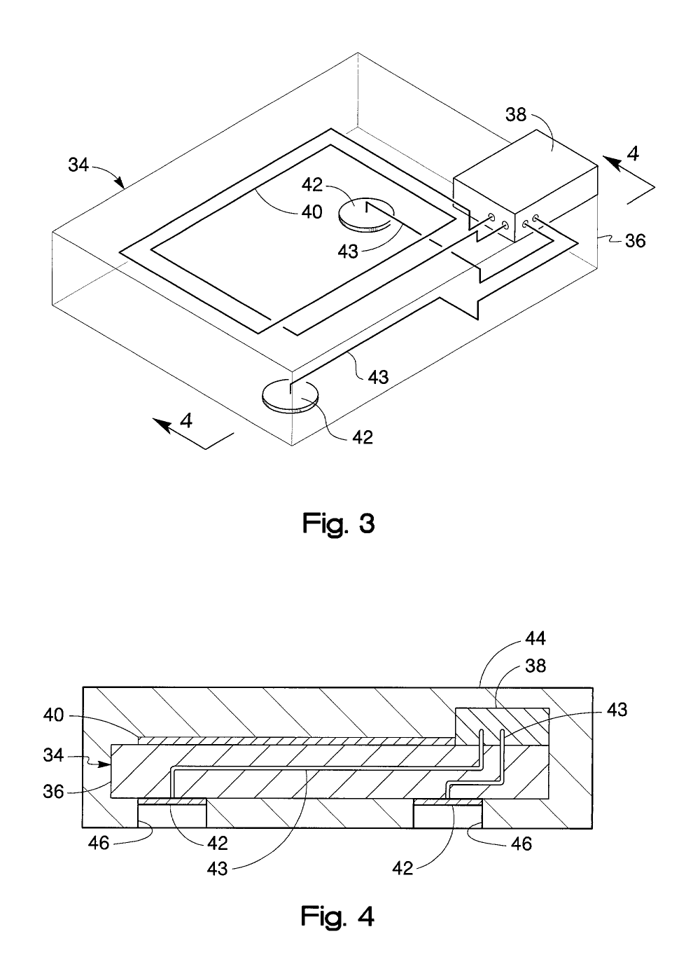

In the exemplary embodiment, the linking device 34 includes a sensor as will be discussed with respect to FIG. 3. Both the linking device 34 and the sensor are disposed within the ink reservoir 24. The linking device 34 passes information through at least one sidewall of the ink reservoir 24 to the printer portion 12.

The linking device 34 is configured to pass information through sidewalls of the reservoir 32 to exchange information between the ink reservoir 24 and controller 34 on the printer portion 12. The exchange of information between the ink reservoir 24 and the printer portion 12 is to ensure the operation of the printer portion 12 is compatible with the ink contained within the replaceable printing component 14 thereby achieving high print quality and reliable operation of the printing system 10.

The controller 28, among other things, controls the transfer of information between the printer portion 12 and the replaceable printing component 14. In addition, the controller 28 controls the transfer of information between the printhead 16 and the controller 28 for activating the printhead to selectively deposit ink on print media. The controller 28 also controls the relative movement of the printhead 16 and print media. The controller 28 performs additional functions such as controlling the transfer of information between the printing system 10 and a host device such as a host computer (not shown).

In order to ensure reliable operation of the printing system 10 it is necessary to identify when the replaceable consumable 14 is out of ink so that operation of the printhead 16 can be halted. Operation of the printhead 16 without ink can result in catastrophic damage to the printhead 16. Information provided by the linking device 34 to the controller 28 allows the controller 28 to identify an out of ink condition so that operation of the printhead 16 can be ceased.

In addition to out of ink information the linking device 34 provides various ink characteristics to the controller 28 for determining accuracy of the out of ink information. For example, the linking device 34 associated with the replaceable consumable 14 can provide characteristics such as ink resistivity and ink capacitance just to name a couple. The controller 28 can use this information to identify the ink composition. In the event the ink composition is recognized then the sensor information for determining the out of ink condition will be accurate. Conversely, in the event that the ink composition is not recognized then the sensor information for determining the out of ink condition will not be accurate and other measures are required for preventing damage to the printheads 16.

FIG. 3 is a top perspective view of the linking device 34 shown in FIG. 2. The linking device 34 includes a substrate 36, link electronics 38, an antenna portion 40 and sensor 42. The link electronics 38 and antenna portion 40 are preferably disposed on the substrate 36. The antenna portion 40 is electrically connected to the link electronics 38. The sensor 42 is preferably disposed on the substrate 36 and is electrically connected to the link electronics 38 by conductors 43.

In one exemplary embodiment, the antenna portion 40 is configured so that when activated signals are emanated of a wavelength selected to pass through sidewalls 32 of the ink reservoir 24. The antenna potion 40 is achieved by forming several turns of a conductor to create a radio frequency antenna portion 40. This radio frequency antenna 40 utilizes a frequency that is capable of penetrating through the sidewall 32 of the ink reservoir 24 to the controller 28.

In this exemplary embodiment, the sensor 42 is a pair of electrically conductive pads that are spaced apart. Each of the pair of electrically conductive pads is electrically connected to the electrical circuit portion 38 by a conductive trace 43. The electrically conductive pads 42 to can be used to measure various ink properties such as conductivity or capacitance, to name a couple. Ink conductivity or ink capacitance is used to determine an out of ink condition within the ink reservoir 24. By placing the sensor 42 proximate a fluid outlet of the ink reservoir 24 an out of ink condition is determined by measuring conductivity or capacitance between the pads of the sensor 42. For example, in the case of conductivity measurement, conductivity will decrease when ink is no longer present between the conductive pads of the sensor, thus signaling an out of ink condition. Out of ink condition can be determined by a change in conductivity or when the conductivity value falls below a threshold value.

Because sensed parameters such as conductivity and capacitance can change as a result of different ink compositions it is necessary to verify that the ink composition has not changed to ensure accuracy of the out of ink signal. Measuring parameters such as ink capacitance in conjunction with ink conductivity the particular ink composition within the ink reservoir 24 can be characterized to determine if the ink composition is the same as the what the out of ink sensing system was designed for and therefore the out of ink signal is accurate.

In contrast, if the ink composition is different from the ink composition the out of ink sensing system was designed for then an out of ink signal may not be generated or if the out of ink signal is generated this signal may be erroneous. Once it is determined the out of ink sensing system no longer has integrity then the printing system 10 can initiate action to protect the printhead 26 from damage. For example, the printer can notify the customer that the out of ink sensing system has lost integrity and require the customer to verify there is sufficient ink in the ink reservoir 24 before resuming the printing process.

FIG. 4 is a cross-section of the linking device 34 taken across lines 4-4 in FIG. 3. The linking device 34 is shown encapsulated by an encapsulant 44 to prevent ink from getting access to and the electrical circuit portion 38 and the antenna 40. Ink used in an inkjet printing tends to include surfactants that if exposed to the electrical circuit portion 38 can cause damage. In addition, ink is conductive and therefore tends to provide unwanted the electrical shorts in the electrical circuit portion 38. The encapsulant 44 is configured to prevent ink access to the electrical circuit portion 38.

The use of the encapsulant 44 allows the linking device 34 to be disposed in the ink reservoir 24 whereby ink parameters can be measured directly by the sensors 42. Because the linking device 30 is coupled through the sidewalls 32 of the ink reservoir 24 then electrical conductors passing through sidewalls 32 are not required. By eliminating routing of electrical conductors through the sidewalls 32 of the ink reservoir 24 the reliability and cost of the ink reservoir 24 tends to be reduced. In the exemplary embodiment, the ink capsule and 44 is a plastic carrier.

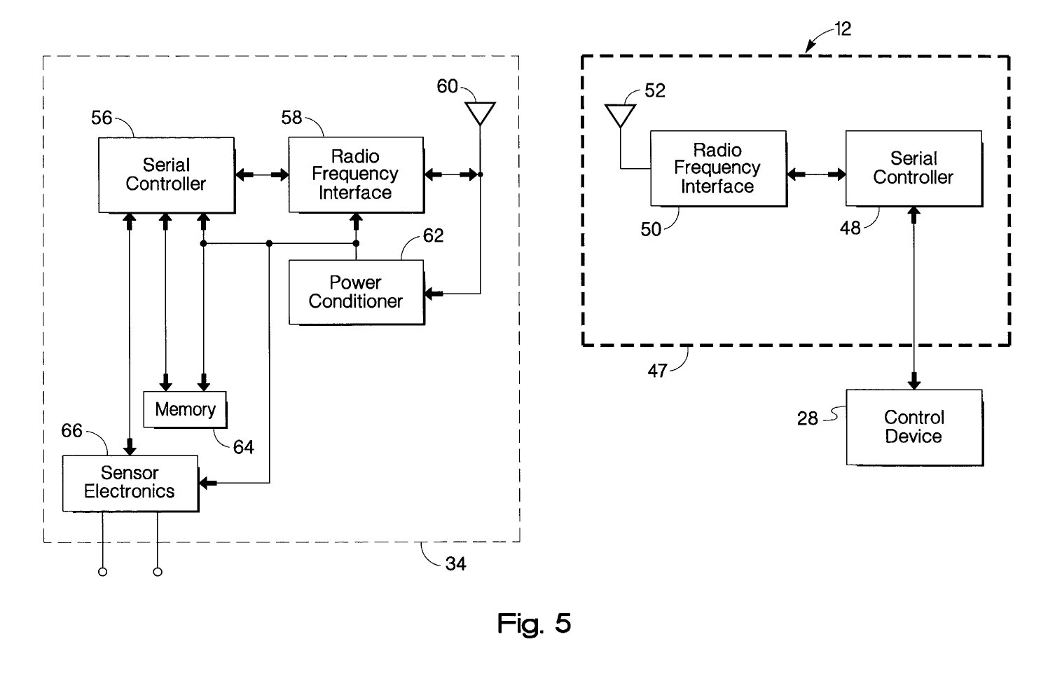

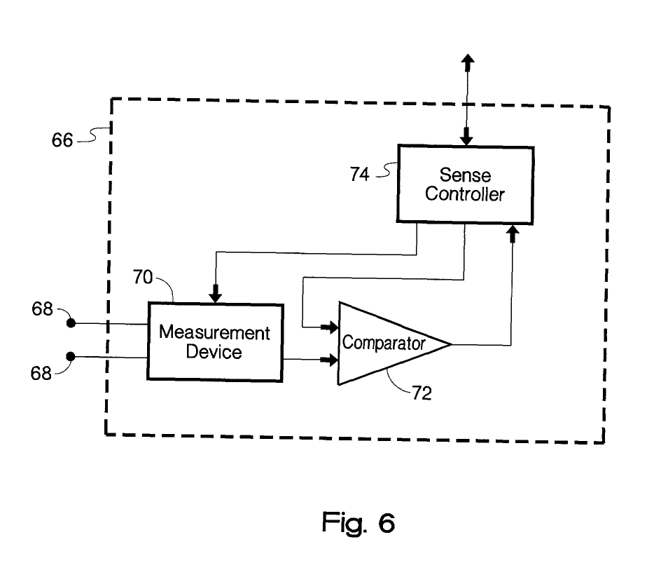

The encapsulant 44 defines openings 46 that allow ink access to the sensor 42. The sensor 42 determines parameters such as capacitance and conductivity of ink within the ink reservoir 24. Parameters sent by the sensors can then be used by the printing system 12 to determine an ink level or ink type within the reservoir 24. The electrical circuit portion 38 that is electrically connected to the sensor 42 will now be discussed in more detail with respect to FIGS. 5 and 6.

FIG. 5 depicts further detail of the linking device 34 for transferring information between the replaceable printing component 14 and the printer portion 12. The printer portion 12 includes a linking device 47 that is similar to the linking device 34. The linking device 47 includes a serial controller 48, a radio frequency interface 50, and an antenna 52. The serial controller 48 controls the transfer of information between the controller 28 associated with the printing system 10 and the radio frequency interface 50. The serial controller 48 is preferably a microprocessor, a programmable controller or a hardware-implemented controller that performs the necessary interface and data manipulation functions for passing information between the controller 28 and the radio frequency interface 50.

Information transferred between the controller 28 and the serial controller 48 includes command information for requesting ink level information and ink status information. This command information is provided to the linking device 34, whereupon the linking device 34 provides the requested ink level or status information. In one exemplary embodiment, information is transferred between the serial controller 48 and the controller 28 in a parallel format, and information is transferred between the serial controller 48 and the radio frequency interface 50 in a serial format.

The radio frequency interface 50 receives information from the serial controller 48 in a serial fashion and converts this information into time varying voltages at the antenna 52. These time varying voltages are preferably in a standard radio frequency range such as 125 kilohertz to 13.56 megahertz. Radio frequencies outside this range may also be suitable. Transmission of information using a radio frequency technology is used in financial transaction cards provided by financial institutions for various types of transactions such as banking and using debit cards and credit cards. These financial transaction cards are sometimes referred to as “smart cards”. Similar technology is also used in inventory systems that are sometimes referred to as radio frequency identification (RFID) technology.

The linking device 34 associated with the replaceable printing device 14 is similar to the linking device 47 associated with the printer portion 12. The linking device 34 includes a serial controller 56, a radio frequency interface 58 and an antenna 60, each of which are similar to corresponding features of the linking device 47. Voltages are induced on antenna 60 in response to time varying voltages provided to antenna 52. Information is extracted from the time varying voltages induced on antenna 60 by the radio frequency interface 58. Information is passed from the radio frequency interface 58 to the serial controller 56. In response to command information, the serial controller 56 can store information such as ink parameter information or ink level information in an electrical storage device or memory 64. The serial controller 56 also selectively passes information from either the memory 64 or sensor electronics 66 to the radio frequency interface 58. The particular information provided to the radio frequency interface is either predetermined or is selectable based on command information received from the printer portion 12.

The linking device 34 on the replaceable printing component 14 includes sensor electronics 66 that are electrically connected to the sensor 42 (not shown). The sensor electronics 66, which will be discussed in more detail with respect to FIG. 6, is responsive to command information for retrieving information from the sensor electronics 66. The information such as ink level information and ink parameter information is transferred to the serial controller 56 to be sent to the link 47 associated with the printer portion 12 in a manner similar to the transfer of information from the link 47 to link 34.

FIG. 6 shows greater detail of the sensor electronics 66 shown in FIG. 5. The sensor electronics 66 include a pair of external terminals 68 that are connected to the sensor 42. The sensor electronics 66 also include a measurement device 70 that is electrically connected by way of external terminals 68 to the sensor 42, a comparator 72 and a sense controller 74.

The measurement device 70 receives an electrical signals from the sensor 42 indicative of ink parameter information as well as indicative of an out of ink condition within the ink reservoir 32. In addition, the measurement device 70 receives control information from the sense controller indicating what type of measurement is requested. The measurement device provides a measurement value indicative of the measured parameter to the comparator 72.

The measurement device 70 is capable of making a variety of different types of measurements. One type of measurement the measurement device 70 is configured to make is to measure resistance or conductivity between the sensors 42. Another type of measurement the measurement device is capable of is measurement of capacitance between the sensors 42. The printer portion 12 makes use of this measured information in a variety of ways, such as, for determining ink level information and for determining ink type, to name a couple of uses. A variety of other measurements can also be made by the measurement device that are suitable for characterizing ink within the ink reservoir 32.

The comparator 72 compares the measured value provided by the measurement device 70 to a reference value provided by the sense controller 74. The reference value is provide by the serial controller 56 or is generated by the sense controller 74. The reference value, in general, will be different for each parameter measured. For example, the reference value will be a first value for measuring conductance for determining an absence of ink between the sensors 42. The reference value will be a second value for measuring capacitance between the sensors for determining ink type in the ink reservoir 32.

Characterizing the ink within the ink reservoir 32 allows the printer portion 12 to determine if ink within the ink reservoir 32 has the same parameters as ink the sensor 42 and sensor electronics 66 were designed to sense. In the event that the ink within the ink reservoir 32 has been replaced with a different ink with different ink parameters then the integrity of the out of ink sensing system and the customer must be notified to avoid damaging the printheads.

In the exemplary embodiment, each of the link 34, sensor electronics 66 and the electrical storage device 64 is either an active device powered by a battery or a passive device that stores energy in a storage device such as a capacitor. In the case of a passive device, energy is provided to the capacitor by voltages induced on the antenna 60. In the exemplary embodiment, voltages are induced on the antenna 60 due to time varying voltages that are applied to the antenna 52 by the radio frequency interface 50. The induced voltage at the antenna 60 is provided to a power conditioner (not shown) which converts these time varying voltages into a single polarity voltage that is suitable as a supply voltage for each of the electrical storage device 64, the serial controller 56, the radio frequency interface 58 and sensor electronics 66. In one exemplary embodiment, the power conditioner rectifies a time varying voltage that is induced on the antenna 60 and filters this rectified voltage to provide a suitable supply voltage.

The present invention is applicable to a variety of other types of printing systems 10 as well. For example, the present invention is suitable for use with electro photographic printing systems. In the case of electro photographic printing systems, the replaceable printing component 14 is a replaceable component such as a supply of printing material usually referred to as a toner cartridge. The sensor 42 determines toner level information from the toner cartridge and provides this information to the printer portion using the wireless connection established by linking devices 34 and 47. The printer portion 12 notifies the customer of a low toner condition or an out of toner condition so that the toner cartridge can be replaced. The printer portion also notifies the customer if integrity of the out of toner system is not operating properly.

The use of the linking device 34 that is immersed in ink within the replaceable ink reservoir 32 provides a relatively low cost method for determining status such as an out of ink condition. Disposing the linking device 34 in the ink reservoir 34 allows for ink level and ink parameters to be measured using a relatively low cost manufacturing techniques.

What is claimed is:

1. An ink level sensing system for determining ink level in an ink reservoir and providing this ink level information to a printing system, the ink level sensing system comprising:
an ink reservoir having a radio frequency interface disposed therein,
a printing device configured for receiving the ink reservoir, the printing device including a radio frequency interface for receiving ink level information that is coupled through the ink reservoir by the radio frequency interface within the ink reservoir.

2. The ink level sensing system of claim 1 further including a sensor electrically connected to the radio frequency interface disposed within the ink reservoir, the sensor providing a sensor output signal indicative of ink level within the ink reservoir to the radio frequency interface.

3. The ink level sensing system of claim 1 wherein the ink reservoir includes a sidewall and wherein the radio frequency interface includes an antenna for coupling a radio frequency signal throught the sidewall to the printing system.

4. The ink level sensing system of claim 1 wherein the radio frequency interface within the ink reservoir is enclosed in an encapsulant material and wherein the encapsulant material is at least partially surrounded by ink within the ink reservoir.

5. The ink level sensing system of claim 2 wherein the sensor is a pair of electrodes disposed within the ink reservoir to measure electrical continuity through ink within the ink.

6. The ink level sensing system of claim 2 wherein the sensor is a pair of electrodes disposed within the ink reservoir to measure electrical capacitance between the pair of electrodes.

7. A replaceable printing component for use in a printing system, the replaceable printing component for containing a supply of printing material for use by the printing system to form images on media, the replaceable printing component comprising:
a reservoir for containing printing material; and
a linking device disposed entirely within the reservoir for emitting a signal indicative printing material within the reservoir wherein the reservoir is formed of a material so that the emitted signal passes through the reservoir for providing information to the printing system.

8. The replaceable printing component of claim 7 wherein the linking device is a radio frequency linking device for providing a radio frequency signal.

9. The replaceable printing component of claim 7 wherein the replaceable printing component is a replaceable ink reservoir and wherein the linking device includes a sensor that provides an output signal indicative of ink within the ink reservoir and wherein the output signal is coupled to the printing system by the linking device.

10. The replaceable printing component of claim 7 wherein the replaceable printing component is a replaceable ink reservoir and wherein the linking device includes a sensor having a pair of electrodes disposed within the ink reservoir to measure electrical continuity through ink within the ink reservoir.

11. The ink level sensing system of claim 7 wherein the replaceable printing component is a replaceable ink reservoir and wherein the linking device includes a sensor having a pair of electrodes that are disposed within the ink reservoir to measure capacitance between the pair of electrodes.

12. The ink level sensing system of claim 7 wherein the reservoir does not contain electrical conductors that extends from within the reservoir to a location outside the reservoir.

13. A printing system having a printer portion and at least one replaceable reservoir, the printer portion and the at least one replaceable reservoir exchanging information therebetween, the printing system comprising:
a first wireless link associated with the replaceable reservoir, the first wireless link disposed entirely within the replaceable reservoir; and
a second wireless link associated with the printer portion, the second wireless link receiving replaceable reservoir information from the first wireless link by transmission of information in a wireless manner.

14. The printing system of claim 13 wherein the first wireless link is a radio frequency transmitter for transmitting a radio frequency signal and the second wireless link is a radio frequency receiver for receiving the radio frequency signal and determining the replaceable reservoir information based thereon.

15. The printing system of claim 13 wherein the replaceable reservoir is a replaceable ink reservoir and wherein the replaceable reservoir information is ink level information for the replaceable ink reservoir.

16. The printing system of claim 13 wherein the first wireless link includes a pair of electrodes are disposed in the replaceable reservoir to measure electrical continuity of ink within the replaceable reservoir.

17. The printing system of claim 13 wherein the first wireless link includes a pair of electrodes disposed in the replaceable reservoir to measure capacitance between the pair of electrodes.

18. The printing system of claim 13 where the printer portion is an ink jet printer and wherein the replaceable reservoir contains ink.

19. A method for transferring status information from a replaceable printing component to a printer portion, the method comprising:
determining status information of the replaceable printing component using a sensor disposed within the replaceable printing component; and
transferring status information using a wireless link through a sidewall of the replaceable printing component to the printer portion.

20. The method of claim 19 wherein the replaceable printing component is an ink reservoir and the printer portion is an ink jet printer and wherein the status information is ink level information in the ink reservoir.

21. The method of claim 19 wherein the transferring status information is accomplished by providing a radio frequency signal that couples through a sidewall of the replaceable printing component.

22. A replaceable ink container for providing ink to an inkjet printing system, the replaceable ink container including:
a sensing system for sensing parameters of ink within an ink container wherein ink type within the replaceable ink container is determined by the inkjet printing system based on the sensed parameters.

23. The replaceable ink container of claim 22 wherein the sensing system includes a pair of electrodes are disposed in the replaceable ink container for measuring electrical continuity of ink within the replaceable ink container.

24. The replaceable ink container of claim 22 wherein the sensing system includes a pair of electrodes for measuring capacitance between the pair of electrodes.

25. The replaceable ink container of claim 22 wherein the sensing system senses more than one parameter of ink within the ink container.
